(19) United States
(12) Patent Application Publication
(10) Pub. No.: US 2004/0114536 A1
(43) Pub. Date: Jun. 17, 2004

(54) Method for communicating information on fast and slow paths

(76) Inventor: Aidan O'Rourke, Irvine, CA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/683,465

(22) Filed: Oct. 14, 2003

Related U.S. Application Data
(60) Provisional application No. 60/418,352, filed on Oct. 16, 2002.

(51) Int. Cl. H04L 12/28

(52) U.S. Cl. 370/252; 370/395.21; 370/389

(57) ABSTRACT

A method for controlling a packet in a network device includes determining a classification of the packet, the classification correlating to the type of information contained in the packet (e.g., voice, video, data), determining a degree of noise protection processing to apply to the packet based upon the determined classification; and sending the message on either a fast transmission path or a slow transmission path depending on the determined degree of noise protection processing to apply. The fast transmission path relates to a data path where little or no noise protection processing is applied to the packet whereas the slow transmission path relates to a data path where a higher degree of noise protection processing is applied. In certain implementations an interleaver provides the noise protection processing.

### CROSS-REFERENCE TO RELATED APPLICATIONS

This application claims priority under 35 U.S.C. § 119(e) to provisional application Ser. No. 60/418,352, filed on Oct. 16, 2002 by the same inventor and incorporated herein by its reference.

### BACKGROUND OF THE INVENTION

1. Technical Field

This invention relates to systems and methods for delivering a variety of services including multimedia services over a network. More particularly, but not exclusively, the invention relates to distinguishing types of information to be communicated and sending the types of information over the network using fast and slow data paths depending on the type of information.

2. Background Art

In communication networks, there may be problems associated with the transport layer due to outside interference. For example, in the transport of information on a physical link and data link such as Ethernet over telephone twisted pair wire, noise sources may be encountered which can degrade the transport of data over the twisted pair wires (or other cabling such as coaxial cable). Such noise degradation may be caused by, for example, high-energy noise spikes resulting from electric equipment, such as motors and fans, being switched on and off.

One technique that has been used to protect against this kind of impulse noise affecting data transmissions is called interleaving. Interleaving is a data communication technique, used in conjunction with error-correcting codes, to reduce the number of undetected error bursts. Generally, in the interleaving processes, code symbols are reordered before transmission in such a manner that any two successive code symbols are separated by I-1 symbols in the transmitted sequence, where I is called the degree of interleaving. Upon reception, the interleaved code symbols are reordered into their original sequence, thus effectively spreading or randomizing the errors (in time) to enable more complete correction by a random error-correcting code.

A drawback resulting from the interleaving process is a delay in the transmission of data, referred to as “latency.” This delay does not typically effect low priority data transmissions. However, in networks communicating time-sensitive information such as, for example, voice data, a significant delay or interruption in the transmission of the voice data can result in an unacceptable degradation of the overall communication quality from a user standpoint. For example, echoes and delays in voice communications may be frustrating to users trying to communicate with each other.

On the other hand, a delay in broadcast quality video is somewhat acceptable in a voice and video data combination since, from a user standpoint, the actual communication conveyance between users is derived mainly from the voice component. However, if impulse noise affects the video data transmission, it may be highly objectionable to the user since it may cause a significant corruption of the video signal, which often shows up as some kind of blocking or tiling error.

Consequently, in order to protect against the interruption in video quality, a significant degree of interleaving is used for video data. If however, both video and voice data are transmitted along the same physical layer, and the communication is heavily interleaved to promote reasonable video quality, the voice quality is significantly reduced because of the interleaving-induced delay (or latency). Accordingly, it would be desirable to be able to identify and distinguish various types of data to be transmitted and transmit each type of data in a manner that promotes the best communication between users.

In view of the problems described above, a solution is desired for optimizing the latency vs. burst noise immunity tradeoffs for each data type independently on a given transmission link. Accordingly, there is a need for improved systems and methods for delivering multimedia services in a network environment.

### BRIEF SUMMARY OF THE INVENTION

In accordance with one aspect of the present invention, a method of controlling a message in a network device is disclosed which includes determining a classification of the message, determining a degree of noise protection processing to apply to the message based upon the classification; and sending the message on a transmission path corresponding to the determined degree of noise protection processing.

In certain embodiments of the invention, the classification of the message or packet distinguishes whether the message contains a voice component, a video component or a data component. If the classification indicates a voice component is included in the message, little or no degree of noise protection processing is applied to the message. If the classification indicates a video component is included in the message, a higher degree of noise protection is applied to the message.

In optional embodiments, if the classification of the message indicates a data component is included in the message, little or no noise protection processing is applied to the message.

According to another aspect of the invention, a network device is disclosed which includes one or more ports to facilitate sending and receiving a packet into and out of the network device, a processing device including packet inspection logic communicating with the at least one port, the packet inspection logic configured to determine a degree of error correction processing to be applied to the packet based upon the classification of information included in the packet, and an error correction processing portion, which may be included in the processing device or may be a separate device, communicating with the packet inspection logic and configured to apply the degree of error correction processing to the packet determined by the packet inspection logic.

### BRIEF DESCRIPTION OF THE DRAWING

Further aspects, features and advantages of the present invention will become apparent from the following description of the invention in reference to the appended drawing in which like numerals denote like elements and in which:

FIG. 1 is a flow chart detailing a method of communicating data along slow and fast paths according to one embodiment of the invention;

FIG. 2 is a functional block diagram of a network device having a fast path and slow path according to one embodiment of the invention; and

FIG. 3 is a flow chart of a method of communicating data in a network according to another embodiment of the invention.

### DETAILED DESCRIPTION OF THE INVENTION

According to one aspect of the present invention, methods and systems are disclosed for communicating information between nodes of a network using a low latency data path for high priority information not significantly affected by impulse noise and a high latency data path for information more subject to corruption by noise. As used herein a “fast path” is a data path for transmitting data between nodes, where the path has little or no delay resulting from noise reducing manipulation of the data. In contrast, a “slow path” is a data path having a delay resulting from noise protection processing, such as interleaving, being performed on the data message. While the fast path does not necessarily omit the possibility of at least some manipulation of the data messages for example, error detection or error correction, the fast path has a lesser degree of such processing than the slow path and hence a lower latency is experienced on the fast path.

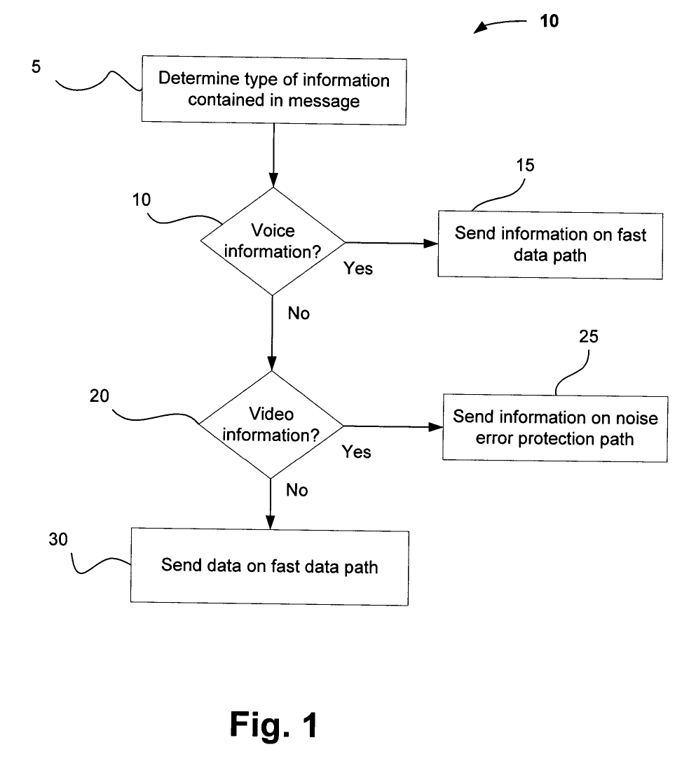

Referring to FIG. 1, a method 10 of sending messages over a network having at least a fast data path and a slow data path includes determining 5 whether the message contains voice, video, or a data information, and sending the message over the fast data path or the slow data path depending on which type of information is contained in the message. For example, if the information is voice related 11, the message is sent 15 over the fast data path. If the information is video related 20, the message is sent 25 over the slow data path (also referred to as the “noise error protection path”). If the information includes non-voice or non-video data (“data information”), the message could be sent over either paths but in one preferred embodiment of the invention, to improve network efficiency, the message is sent 30 over the fast path.

In one preferred implementation of method 10, the information is packet-based, such as that used in TCP/IP systems and the determining step 100 includes identifying what type of information (e.g., voice, video or data information) is contained in each packet. However, the present invention is not limited to packet-based protocols and may be applied to any other suitable transmission protocol or system where similar benefits may be derived.

Identifying what type of information is included in each packet can be performed in any suitable manner. In one example implementation, an identifying value is assigned when the packet is created to identify the type of information (for example, voice, video or data) contained in the packet. This value may be stored in the packet header or payload. The identifying value is used (or could even be assigned) by packet inspection logic in a network device to determine (designate) what type of information component the packet contains.

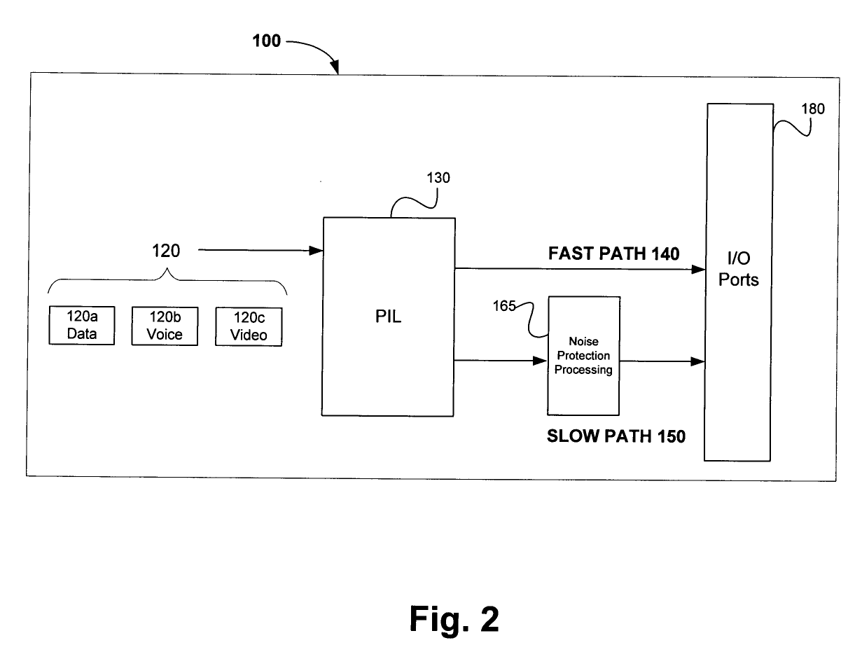

Turning to FIG. 2, a functional block diagram is depicted of a non-limiting example for a packet inspection logic unit 130 in a network device 100 according to an embodiment of the invention. Network device 100 may include a packet inspection logic unit (PIL) 130, a fast data path 140, a slow data path 150, I/O ports 180, and a noise protection processing block 165.

In general, when a request is received by network device 100 to perform a task or to transmit a packet to another network device, device 100 either passes an existing packet 120 (or generates a new packet) for transmission out of device 100.

PIL 130 determines which transmission path will be used for transmitting the requested packet out of network device 100. PIL 130 may also determine the error correction technique that the packet will receive along the selected transmission path based upon the classification of the packet, or example, whether the packet should be transmitted with low latency (e.g., voice information) or with increased protection from noise (e.g., video information).

By way of example, PIL 130 checks the header of the packet to determine whether the requested packet 120 is a data packet 120a, a voice packet 120b or a video packet 120c (e.g., using the assigned value discussed previously). Based upon the classification of packet 120, PIL 130 transfers packet 120 to a transmission path, which may be either a fast path 140 or a slow path 150.

PIL 130 may be configured to classify packets based on several different criteria, including a VLAN tag, as defined in IEEE 802.1Q. The IEEE 802.1Q standard defines the operation of Virtual LAN (VLAN) bridges that permit the operation and administration of VLAN topologies within a bridged LAN infrastructure. PIL 130 may also classify and switch packets based on the Type-of-service (ToS) field of the IP header. A network operator may define a plurality of classes of service using the bits in the ToS field in the IP header or priority bits in the Ethernet header. PIL 130 may also utilize other Quality-of-service (QoS) features for classifying the packets and assigning the appropriate traffic-handling policies, including congestion management, bandwidth allocation, and delay bounds for each traffic class.

When the packet classification is identified, PIL 130 determines the appropriate error correction, which should be applied to that particular class of packet for transmission from network device 100. For example, PIL 130 may be configured to include or communicate with a look-up table (not shown) in order to use the classification data (assigned value) as an identification tag to search the look-up table to determine the appropriate transmission path and the error correction treatment for each packet.

Fast path 140 may be configured such that packets transmitted along this transmission path do not receive any (or a low degree of) interleaving (or other types of noise protection treatment) in device 100. Consequently, the fast path 140 is used for sending packets not requiring, or needing only minor, noise protection or error correction processing. Thus, packets transmitted along fast path 140 are transmitted out of network device 100 via ports 180 and processed by the receiving node at a relatively fast rate, hence the term “fast path”. Packets such as data packets 120a and voice packets 120b are preferably transmitted via fast path 140 to reduce delays and thus, in the example of voice packets 120b, a reasonable quality of service (QoS) can be maintained.

On the other hand, slow path 150 is used for transmitting messages, such as video packets 120c, that receive noise protection processing (such as interleaving) and other manipulation techniques prior to their transmission from network device 100. Thus, an interleaver or other noise protection processing device 165 may be included in slow path 150 to perform desired processing.

While only one fast path 140 and one slow path 150 is shown in FIG. 2, the present invention is not limited to such and may have any number of paths each having varying degrees of latency (due to various amounts of error coding or noise protection processing) along each path. Further, while device 100 is explained in reference to transmitting the messages along fast path 150 or slow path 140, the present invention also applies to receiving messages along fast path 150 or slow path 150. For example, if messages received at device 100 do not include interleaved code symbols that have to be reordered in their original sequence, latency is reduced during reception of messages as well as in their transmission or retransmission. Accordingly, as used herein the term “fast path” may pertain to a low latency data path in the transmission and/or reception path of device 100 itself, as well as a low latency data path (achieved by virtue of the present invention) between device 100 and another node on the network. Similarly the term “slow path” may pertain to the path on device 100 itself or the path between device 100 and another network node.

Noise protection processing device 165, such as an interleaver, is included along slow path 150 to perform error correction. While shown separately, PIL 130 and interleaver 165 may be part of the same overall device such as a PLA or microcontroller.

Device 165 may be, for example, a Reed-Solomon interleaver. The Reed-Solomon encoder takes a block of digital data and adds extra “redundant” bits. Errors occur during transmission or storage for a number of reasons as discussed above. Reed-Solomon decoders can be used to correct errors caused, for example, by noise or interference, and even scratches on a compact disc. The Reed-Solomon decoder processes each block of digital data and attempts to correct errors and recover the original data. The number and type of errors that can be corrected depends on the characteristics of the Reed-Solomon code.

A multi-path interleaved transmission scheme enables network device 100 to avoid subjecting messages (e.g., packet or frames), which do not necessarily require noise protection processing (such as interleaving), to be transmitted out of (or received in) network device 100 via fast path 140 at a lower latency than messages transmitted along slow path 150. Method 10 and/or device 100 may be particularly advantageous in the case of protocols, such as TCP/IP, where an acknowledgement packet needs to be received from the remote node before transmission of the next batch of packets can continue. This is primarily because when the acknowledgement packet is delayed because of excessive interleaving on the transmission link, overall throughput of the link is impaired.

Network device 100 may be a packet-forwarding unit such as a switch and may be used within a network to manage or control the flow of data to a customer or subscriber of a network. For instance, network device 100 may be a switch, hub, repeater, or any other network device, which may be configurable to perform the network functions defined herein.

In one preferred embodiment, network device 100 is an Ethernet switch and accordingly, a message or packet may refer to an Ethernet frame as defined by IEEE 802.x. In another embodiment, network device 100 is embodied in a Digital Subscriber Line (DSL) Physical Layer Device that has been adapted for transmission of Ethernet or IP packets over telephone wire.

Network device 100 may utilize and connect to a local area network (LAN), Wide Area network (WAN), or other networks such as the Internet and World Wide Web. Network device 100 may include a number of network I/O ports 180 which may be well known as PHYs or transceivers and perform Ethernet layer one functions, or such ports may be presented as Media Independent (MII) or similar such interfaces that are designed to connect with external Physical Layer devices.

Network device 100 may also include or be connected to a CPU (not shown) which may perform certain network functions, and which may communicate with, configure, and control other systems and subsystems of network device 100. Network device 100 may include a scheduler (not shown) configured to schedule or queue packets for transmission in or out of network device 100 (e.g., via ports 180).

Device 100 may include a number of interfaces for directly controlling the network device. These interfaces may provide for remote access (e.g., via a network) or local access (e.g., via a panel or keyboard). Accordingly, network device 100 may include external interface ports, such as a USB or serial port, for connecting to external devices, or CPU (not shown) may be communicated with via network ports 180.

Device 100 may be configured to apply both error correction and/or error detection (via device 165) to the packets as they are transmitted/received along the slow path. In one embodiment, processing device 165 may apply error correction and/or error detection to the packets/frames along slow path 150. Error correction differs from error detection techniques, such as parity-checking, in that errors are not only detected but also corrected. Network device 100 may perform error detection by sending only enough extra information along with the transmission of the requested packet to detect an error when the packet arrives at the destination node so that, if a significant enough error occurs, a request for a retransmission can be sent back to the source node.

In certain embodiments of the invention, both error correction and error detection are performed on slow path 150. In other embodiments, error detection may also be applied to the fast path 140. For example, fast path 140 may include error detection processing while slow path 150 includes error correction processing.

One type of error detection that may be employed is a parity check, where a parity bit is appended to a block of data for the purpose of identifying whether the bits arrived at the destination network device successfully. Another error detection strategy, is the use of a cyclic redundancy checksum (CRC), wherein the source network device appends a bit sequence, called a frame check sequence, to every packet or frame. The resulting frame is divisible by a predetermined number. If there is a remainder, the frame is considered corrupted and a retransmission is requested. Error detection and error correction techniques, including interleaving, are well known in the art and thus not explored in detail in this disclosure.

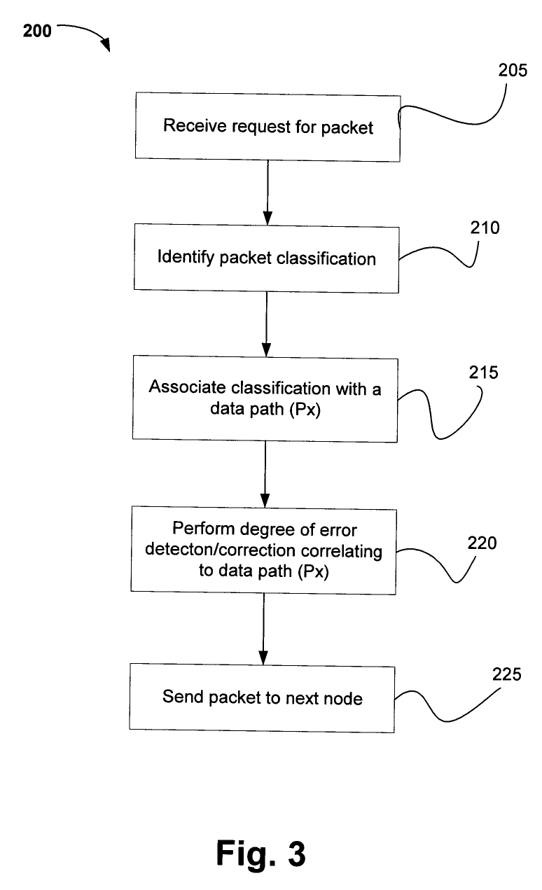

Turning to FIG. 3, an exemplary method 200 for transmitting packets in a network according to an embodiment of the invention includes: in a network device such as a switch, receiving a request to perform an instruction or to transmit a packet to another network device 205. The device determines 210 the class of information in a packet to be sent (for example, PIL 130 (FIG. 2) determines whether the packet is a data packet, a voice packet or a video packet). A data path (Px) associated with the particular classification of the packet is then identified 215, and the packet is directed 220 along the associated data path (Px). A degree of error correction or error detection correlating to data path (Px) is performed 225, and the packet is sent 230 from the device to the next device.

In fact, the degree of error detection/correction processing may vary between data types depending on a predetermined classification system. For example, the degree of latency for voice data might vary depending on a subscriber's needs. Additionally, certain types of non-video and non-voice related data may have different degrees of priority. Accordingly, the classification in method 200 may be assigned as desired according to the degree of latency that might be permissible verses the degree of impulse noise protection desired.

Additionally, the term “data path” or “path” is not limited to an actual physical path for data transfer as, if error correction or error detection processing is implemented by software rather that discreet components, the physical path might be the same but the degree of packet processing is effected by a processor or logic array. Accordingly, in such a software implementation, steps 215 and 220 could be implemented by respectively associating (215) a degree of error detection/correction with the packet classification and/or performing (220) a degree of error detection/correction associated with the packet classification. Alternate arrangements for implementing the present invention are also possible without departing from the scope of the invention.

Therefore, unless contrary to physical possibility, the inventor envisions the methods and systems described herein: (i) may be performed in any sequence and/or combination; and (ii) the components of respective embodiments combined in any manner. Further, although there have been described preferred embodiments of this novel invention, many variations and modifications are possible and the embodiments described herein are not limited by the specific disclosure above, but rather should be limited only by the scope of the appended claims and their legal equivalents.

The invention claimed is:

1. A method of controlling a message in a network device, said method comprising:
determining a classification of said message;
determining a degree of noise protection processing to apply to said message based upon said classification; and
sending the message on a transmission path corresponding to the determined degree of noise protection processing.

2. The method of claim 1 wherein the transmission path comprises at least one fast path corresponding to a low degree of noise protection processing and at least one slow path corresponding to a higher degree of noise protection processing than the at least one fast path.

3. The method of claim 2 wherein one of the at least one fast path does not includes any noise protection processing.

4. The method of claim 1 wherein the noise protection processing comprises interleaving.

5. The method of claim 1 wherein the classification of the message identifies whether the message includes a voice component, a video component or a data component.

6. The method of claim 5 wherein if the classification of the message identifies the message to include the voice component, the transmission path corresponds to a fast path having low or no degree of noise protection processing and if the classification of the message identifies the message to include the video component, the transmission path corresponds to a slow path having a higher degree of noise protection processing.

7. The method of claim 6 wherein the noise protection processing comprises interleaving.

8. The method of claim 7 wherein the network device comprises an Ethernet switch.

9. The method of claim 7 wherein the network device comprises a Digital Subscriber Line (DSL) physical layer device adapted for transmission of Ethernet or IP packets over a telephone wire.

10. The method of claim 6 wherein if the classification of the message identifies the message as including the data component, the transmission path corresponds to the fast path.

11. A network device comprising:
at least one port to facilitate sending and receiving a packet into and out of the network device;
a packet inspection logic communicating with the at least one port, the packet inspection logic configured to determine a degree of error correction processing to be applied to said packet based upon a classification of information included in the packet; and
an error correction processing portion communicating with the packet inspection logic and the at least one port and configured to apply the degree of error correction processing to the packet determined by said packet inspection logic.

12. The network device of claim 11 wherein the classification of information included in the packet correlates to whether the packet includes a voice component, a video component or a data component.

13. The network device of claim 12 wherein if the classification correlates to the voice component, the packet inspection logic sends the packet on a fast data path where little or no error correction processing is applied to the packet by the error correction processing portion, and wherein if the classification correlates to the video component, the packet inspection logic sends the packet on a slow data path where the degree of error correction processing applied to the packet by the error correction processing portion is higher as compared to the fast data path.

14. The network device of claim 13 wherein if the classification correlates to the data component, the packet inspection logic sends the packet on the fast data path.

15. The network device of claim 12 wherein the error correction processing portion comprises an interleaver.

16. The network device of claim 11 wherein the device comprises an Ethernet switch.

17. The network device of claim 11 wherein the device comprises a Digital Subscriber Line (DSL) physical layer device adapted for transmission of Ethernet or IP packets over a telephone wire.

18. A network device comprising:
I/O port means for sending and receiving a packet into and out of the network device;
packet inspection logic means communicating with the port means, the packet inspection logic means for determining a transmission path having a degree of error correction processing to be applied to said packet based upon a classification of information included in the packet and for sending the packet on the determined transmission path; and
error correction processing means communicating with the packet inspection logic means and the port means, the error correction processing means for applying the degree of error correction processing to the packet.

19. The network device of claim 18 wherein the classification of information included in the packet corresponds to a voice component, a video component, or a data component.

20. The network device of claim 19 wherein if the classification correlates to the voice component, the packet inspection logic means sends the packet on a fast data path where little or no error correction processing is applied to the packet by the error correction processing means, and wherein if the classification correlates to the video component, the packet inspection logic means sends the packet on a slow data path where the degree of error correction processing applied to the packet by the error correction processing portion is higher as compared to the fast data path.

21. The network device of claim 20 wherein if the classification correlates to the data component, the packet inspection logic means sends the packet on the fast data path.
